(19) United States
(12) Patent Application Publication
(10) Pub. No.: US 2025/0026241 A1
(43) Pub. Date: Jan. 23, 2025

(54) Cooling Plate and Assembly for Swappable Electric-Vehicle Batteries

(71) Applicant: Ample, Inc., San Francisco, CA (US)

(72) Inventor: Sung Chan Cho, Fullerton, CA (US)

(21) Appl. No.: 18/775,168

(22) Filed: Jul. 17, 2024

Related U.S. Application Data
(60) Provisional application No. 63/514,234, filed on Jul. 18, 2023.

(51) Int. Cl. B60L 58/26; H01M 10/613; H01M 10/625; H01M 10/647; H01M 10/6556

(52) U.S. Cl. CPC B60L 58/26; H01M 10/613; H01M 10/625; H01M 10/647; H01M 10/6556; H01M 2220/20

(57) ABSTRACT

A cooling plate includes an inlet port, an outlet port, a planar first metal sheet, and a second metal sheet disposed on the first metal sheet. The second metal sheet has stamped and crimped regions that define one or more fluid channels to circulate a cooling fluid within the cooling plate, the one or more fluid channels fluidly coupled to the inlet port and the outlet port. The cooling plate can be in thermal communication with a battery module for an electric vehicle.

### CROSS-REFERENCE TO RELATED APPLICATIONS

This application claims priority to U.S. Provisional Application No. 63/514,234, titled “Cooling Plate and Assembly For Swappable Electric-Vehicle Batteries,” filed on Jul. 18, 2023, which is hereby incorporated by reference.

### TECHNICAL FIELD

This application relates generally to electric vehicles (EVs) and their battery components.

### BACKGROUND

The discharge capacity of batteries is reduced faster when the batteries are stored at high temperatures compared to at low temperatures. It would be beneficial to maintain the batteries in EVs at reduced temperatures to extend battery life.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a cooling plate comprising an inlet port; an outlet port; a planar first metal sheet; and a second metal sheet disposed on the first metal sheet, the second metal sheet having stamped and crimped regions that define one or more fluid channels to circulate a cooling fluid within the cooling plate, the one or more fluid channels fluidly coupled to the inlet port and the outlet port.

In one or more embodiments, at the crimped regions the second metal sheet is in direct physical contact with the first metal sheet. In one or more embodiments, the one or more fluid channels correspond to one or more gaps between the first and second metal sheets, each gap defined by a respective stamped region and a respective pair of neighboring crimped regions. In one or more embodiments, at the crimped regions the second metal sheet is pressed, crimped, brazed, welded, and/or or adhered to the first metal sheet. In one or more embodiments, the first and second metal sheets comprise aluminum.

Another aspect of the invention is directed to a thermally regulated energy storage assembly comprising a battery module; a cooling plate in thermal communication with the battery module, the cooling plate having an inlet port, an outlet port, and comprising a planar first metal sheet; and a second metal disposed on the first metal sheet, the second metal sheet having stamped and crimped regions that define one or more fluid channels to circulate a cooling fluid within the cooling plate, the one or more fluid channels fluidly coupled to the inlet port and the outlet port.

In one or more embodiments, the battery modules includes a housing; a plurality of battery cells disposed in the housing; and a thermally conductive plate having a plurality of holes, each battery cell disposed in a respective hole. In one or more embodiments, the thermally conductive plate comprises a metal.

In one or more embodiments, at the crimped regions the second metal sheet is in direct physical contact with the first metal sheet. In one or more embodiments, the one or more fluid channels correspond to one or more gaps between the first and second metal sheets, each gap defined by a respective stamped region and a respective pair of neighboring crimped regions. In one or more embodiments, the assembly further comprises one or more vibration dampeners disposed on the cooling plate. In one or more embodiments, the assembly further comprises one or more vibration dampeners disposed on the battery module.

Another aspect of the invention is directed to a thermally regulated assembly for swappable energy storage devices, comprising an interface plate configured to be mechanically and electrically coupled to an electric vehicle; a battery tray releasably attached to the interface plate; at least one battery module disposed on the battery tray; a cooling plate in thermal communication with the battery module, the cooling plate having an inlet port, an outlet port, and comprising: a planar first metal sheet; and a second metal disposed on the first metal sheet, the second metal sheet having stamped and crimped regions that define one or more fluid channels to circulate a cooling fluid within the cooling plate, the one or more fluid channels fluidly coupled to the inlet port and the outlet port.

In one or more embodiments, each battery module comprises a housing; a plurality of battery cells disposed in the housing; and a thermally conductive plate having a plurality of holes, each battery cell disposed in a respective hole. In one or more embodiments, the assembly further comprises a spring mesh layer in direct physical contact with the at least one battery module; and a thermally conductive metal layer in direct physical contact with the spring mesh layer and the interface plate, wherein the cooling plate is disposed in a hole in the interface plate and in direct physical contact with the thermally conductive metal layer. In one or more embodiments, the assembly further comprises a plurality of vibration dampeners attached to the interface plate and the cooling plate. In one or more embodiments, the assembly further comprises a plurality of vibration dampeners attached to the interface plate and the at least one battery module.

In one or more embodiments, at the crimped regions the second metal sheet is in direct physical contact with the first metal sheet, and the one or more fluid channels correspond to one or more gaps between the first and second metal sheets, each gap defined by a respective stamped region and a respective pair of neighboring crimped regions.

In one or more embodiments, the assembly further comprises a plurality of heat pipes disposed on and in direct physical contact with at least one battery module. In one or more embodiments, each heat pipe includes first and second segments, each first segment in direct physical contact with a first side of a respective battery module, each second segment in direct physical contact with a second side of the respective battery module, each second segment disposed between the cooling plate and the second side of the respective battery module.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a bottom view of an electric vehicle according to an embodiment.

FIG. 2 is a cross section of a portion of the electric vehicle shown in FIG. 1 to illustrate an assembly for one or more swappable energy storage devices according to an embodiment.

FIG. 3 is an isometric view of an interface plate and multiple cooling plates according to an embodiment.

FIG. 4 is another isometric view of an interface plate and multiple cooling plates according to an embodiment.

FIG. 5 is another cross-sectional view of the assembly shown in FIG. 2 according to an embodiment.

FIG. 6A is a top view of a cooling plate according to an embodiment.

FIG. 6B is a cross section of the cooling plate illustrated in FIG. 6A according to an embodiment.

FIG. 6C is an isometric view of the cooling plate according to an embodiment.

FIG. 6D is an isometric view of the cooling plate disposed on a battery tray and battery modules according to an embodiment.

FIGS. 7-10 are cross sections of a portion of the electric vehicle shown in FIG. 1 to illustrate different embodiments of a thermally regulated assembly for one or more swappable energy storage devices.

FIG. 11 is an isometric view of a conductive heat pipe according to an embodiment.

FIG. 12 is a graph that illustrates the effect of high temperature calendar aging on battery cells.

### DETAILED DESCRIPTION

A cooling plate having one or more fluid channels defined therein is placed in thermal communication with swappable battery modules for an electric vehicle (EV). Cooling fluid circulates through the fluid channels to remove heat energy and reduce the temperature of the swappable battery modules, which produce heat energy during use (e.g., as they are discharged). The cooling plate can be formed of a thermally conductive material or metal.

In some embodiments, the cooling plate includes top and bottom metal sheets. The bottom metal sheet can be flat or planar. The top metal sheet can be a planar metal sheet that is stamped or raised, away from the top metal sheet, to form fluid channels and bonded (e.g., pressed, crimped, brazed, welded (e.g., laser welded), and/or glued (e.g., with weld-grade glue)) to partially of fully fluidly seal the fluid channels and improve the mechanical integrity of the cooling plate.

Vibration dampeners can be used to reduce vibration and shock to the battery modules. The vibration dampeners can comprise rubber (or another material) or a metal mesh spring.

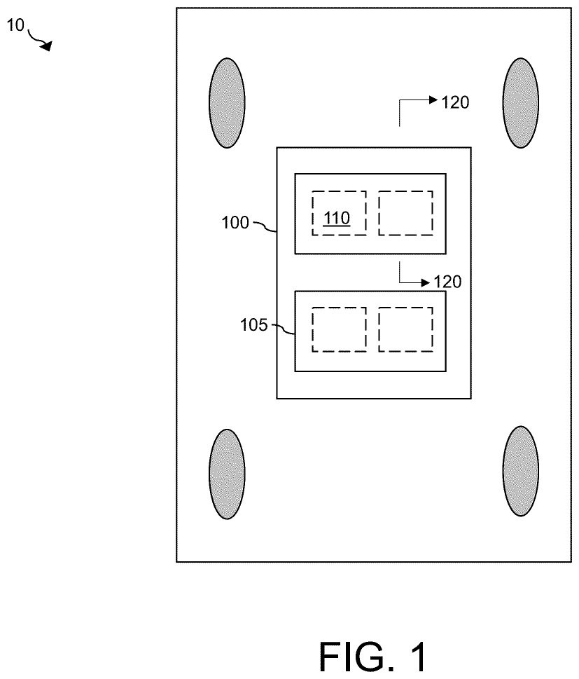

FIG. 1 is a bottom view of an EV 10 according to an embodiment. The EV 10 includes an interface plate 100 that is attached to the bottom of the EV 10. One or more battery trays 105 is/are releasably mechanically attached to the interface plate 100. Each battery tray 105 includes one or more battery modules (or batteries) 110. The interface plate 100 is electrically coupled to the battery module(s) 110 in each battery tray 105 and to the EV 10. For example, the battery module(s) 110 are electrically coupled to the drive train of the EV 10 such that electric energy from the battery modules 110 can be used to power the EV 10. When the battery modules 110 are low in energy, they can be replaced or swapped with charged battery modules. The battery module(s) 110 is/are between a respective battery tray 105 and the interface plate 100 and are shown in dashed lines for illustration purposes only to indicate that the battery module(s) 110 is/are not normally viewable through the battery tray(s) 105.

The interface plate 100 can be the same as described in U.S. Patent Application Publication No. 2024/0067003, titled “Interface for Coupling Electric Battery and Vehicle Systems,” published Feb. 29, 2024 and/or in U.S. Pat. No. 11,858,328, titled “Interface for Coupling Electric Battery and Vehicle Systems,” issued Jan. 2, 2024, which are hereby incorporated by reference.

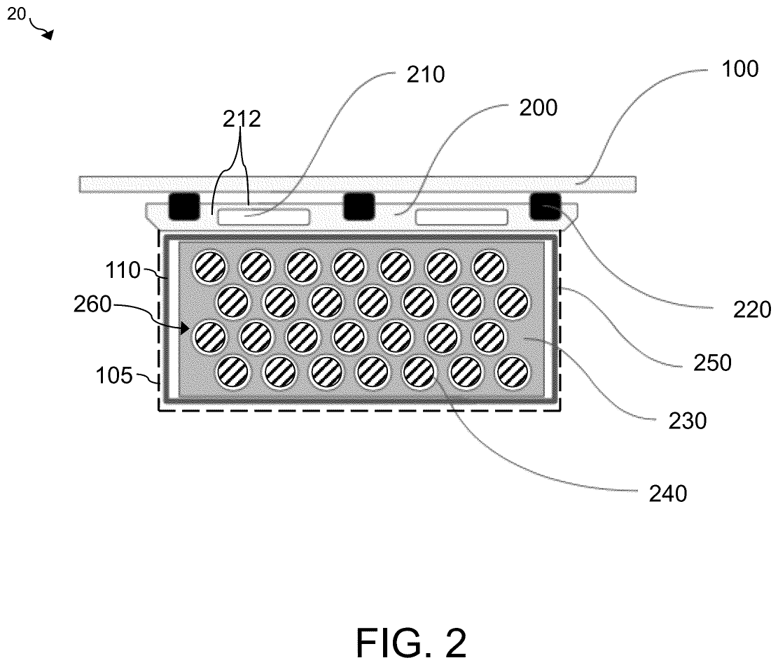

FIG. 2 is a cross section taken through plane 120 in FIG. 1 to illustrate an assembly 20 for one or more swappable energy storage devices according to an embodiment. A cooling pad or plate 200 (in general cooling plate 200) is disposed between the interface plate 100 and the battery module 110. The cooling plate 200 includes one or more fluid channels 210 through which a cooling fluid (e.g., a cooling liquid) can flow. For example, the cooling fluid can flow through a first fluid channel 210 in a first direction (e.g., out of the page in FIG. 2) and through a second fluid channel 210 in a second direction (e.g., into the page in FIG. 2) in a fluid loop/circuit. In one example, the cooling fluid is a 50:50 mixture of water and glycol, though other mixture ratios or other cooling fluids can be used.

The cooling plate 200 is formed out of (e.g., comprises or consists of) a thermally conductive material, such as a thermally conductive metal (e.g., aluminum, copper, brass, steel, and/or another metal). The cooling plate 200 can be in direct physical contact with the battery module 110. Heat produced by the battery module 110 (e.g., as it discharges) can flow through and/or into the cooling plate 200 such as via conduction and/or radiation. The cooling plate 200 is cooled by the cooling fluid which is in direct physical contact with the walls 212 defining the fluid channel(s) 210.

In some embodiments, vibration dampers 220 can be attached to and disposed between the cooling plate 200 and the interface plate 100. The vibration dampeners 220 can reduce vibration of the battery module 110 and the cooling plate 200 for example as the EV 10 is driving. The vibration dampers 220 can comprise an elastomer such as rubber or another material.

For additional cooling, a thermally conductive plate 230 can be disposed in the battery module 110. The thermally conductive plate 230 can surround and can be in direct physical contact with each of the battery cells 240 in the battery module 110. The battery cells 240 can be disposed in respective holes 260 or cavities defined in the thermally conductive plate 230. The battery cells 240 can be cylindrical or another shape. The holes 260 are configured to receive the battery cells 240 and can be the same shape as and/or a complementary shape to that of the battery cells 240.

The conductive plate 230 includes or consists of a thermally conductive material, such as a thermally conductive metal (e.g., aluminum, copper, brass, steel, and/or another metal), which can be the same as or different than the thermally conductive material for the cooling plate 200. Heat produced by the battery cells 240 can conduct through the conductive plate 230 to a battery-module housing 250 which can dissipate the heat through radiation and/or convection (e.g., by air passing over/across the housing 250 as the EV 10 is driven).

The battery-module housing 250 can include or consist of a metal or a plastic, which can be thermally conductive. For example, the battery-module housing 250 can include or consist of a thermally conductive material such as a thermally conductive metal (e.g., aluminum, copper, brass, steel, and/or another metal), which can be the same as or different than the thermally conductive material for the cooling plate 200 and/or for the conductive plate 230.

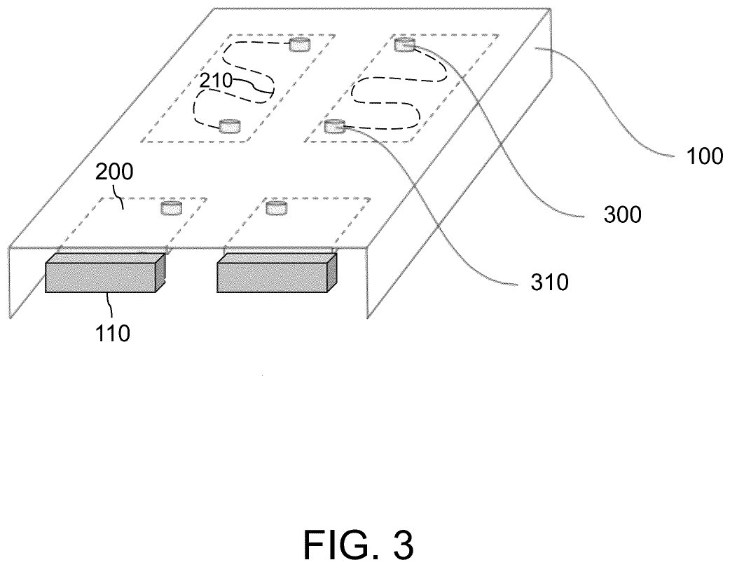

FIG. 3 is an isometric view of the interface plate 100 and multiple cooling plates 200 according to an embodiment. Each cooling plate 200 includes a respective inlet hole or port (in general, inlet port) 300 and a respective outlet hole or port (in general, outlet port) 310. The cooling fluid enters each cooling plate 200 through the respective inlet port 300, passes through one or more respective fluid channel(s) 210, and exits the cooling plate 200 through the respective outlet port 310. The respective fluid channel(s) 210 is/are fluidly coupled to the respective inlet port 300 and to the respective outlet port 310.

Example battery modules 110 are illustrated without battery trays 105.

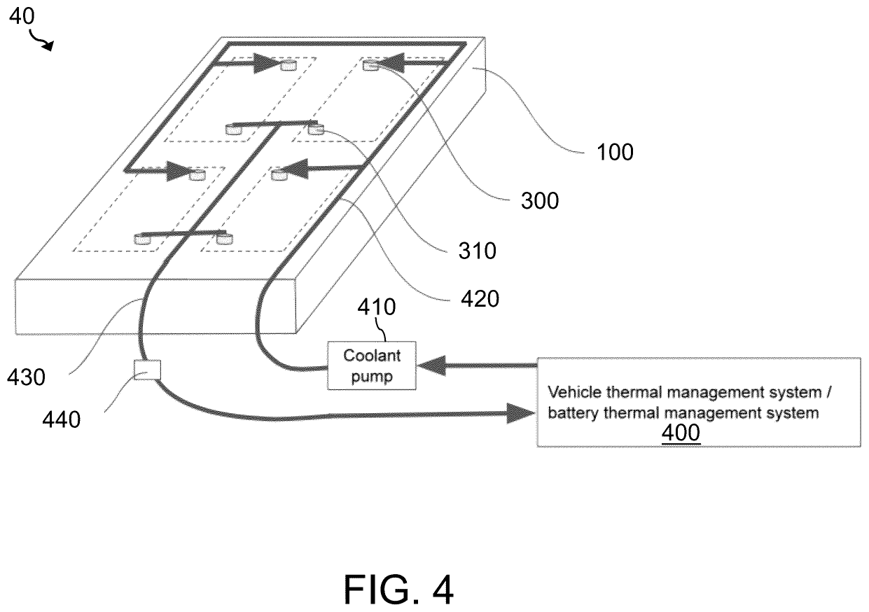

FIG. 4 is another isometric view of the interface plate 100 and multiple cooling plates 200 to illustrate an example of a cooling fluid circuit 40 according to an embodiment. The cooling fluid circuit 40 includes a thermal management system 400, a pump 410, an outlet fluid line 420, a return fluid line 430, and a temperature sensor 440.

The thermal management system 400 can be or include the EV thermal management system (e.g., that provides thermal regulation to other portions of the EV in addition to the battery modules) or a dedicated thermal management system for the battery modules. The thermal management system 400 can include one or more microprocessor-based controllers, coolant system(s) (e.g., heat pump(s), chiller(s), refrigeration system(s), compressor(s), heat exchanger(s), and/or another coolant system), fluid reservoirs, and/or other components to cool and maintain the temperature of the circulating cooling fluid.

The pump 410 is configured to pressurize the outlet fluid line 420 to force the cooling fluid to flow through the outlet fluid line 420 to the cooling plates 200 and back through the return fluid line 430. The outlet fluid line 420 is fluidly coupled to the inlet port 300 of each cooling plate 200 to supply fresh/cold cooling fluid to the cooling plates 200. The return fluid line 430 is fluidly coupled to the outlet port 310 of each cooling plate 200 to receive spent/warm cooling fluid, which is transported back to the thermal management system 400 for cooling. A vacuum pump can be fluidly coupled to the return fluid line 430 instead of or in addition to the pump 410 being fluidly coupled to the outlet fluid line 420.

The thermal management system 400 can monitor the temperature of the cooling fluid in the return fluid line 430 using the temperature sensor 440, which can comprise a thermocouple or other temperature sensor. Additionally or alternatively, the thermal management system 400 can monitor the temperature of the cooling fluid in the outlet fluid line 420 using a temperature sensor, which can be the same as or different than temperature sensor 440.

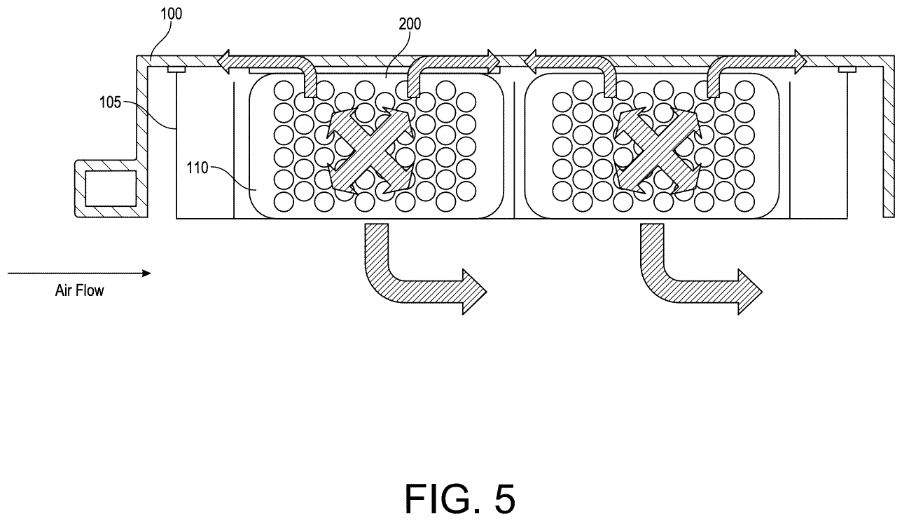

FIG. 5 is another cross-sectional view of assembly 20 illustrating the conductive and convective cooling of the battery modules 110 according to an embodiment. Conductive cooling occurs between the battery modules 110 and the cooling plate 200. Convective cooling occurs at the bottom of the battery tray 105 for heat that is conducted between the battery modules 110 and the battery tray 105, for example due to air flow.

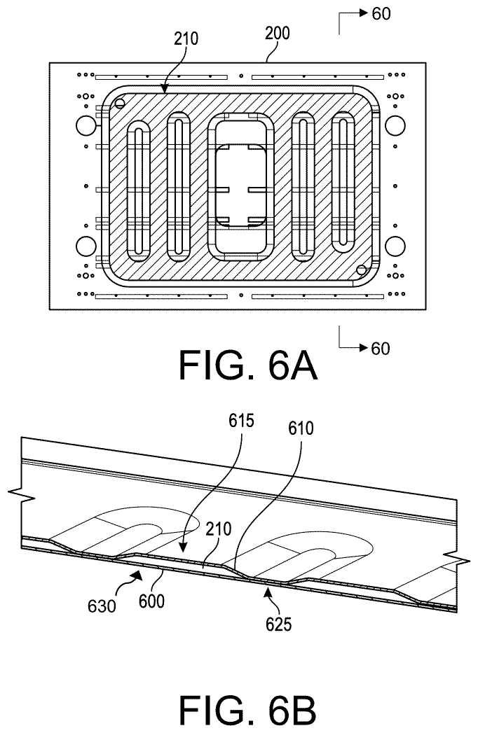

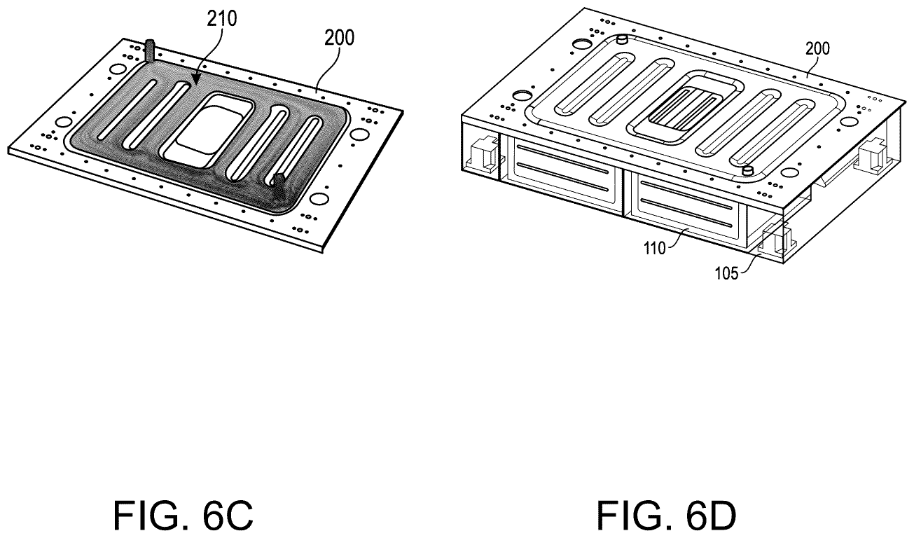

FIGS. 6A-D illustrates various views of the cooling plate 200 according to an embodiment. FIG. 6A is a top view of the cooling plate 200 according to an embodiment. The fluid channel(s) 210 in the cooling plate can be formed or defined using stamped metal (e.g., aluminum) sheets. FIG. 6B is an example cross section of the cooling plate 200 through plane 60 in FIG. 6A according to an embodiment. A bottom metal sheet 600 is flat and/or planar. A top metal sheet 610 is stamped in regions 615 corresponding to the fluid channels 210. In the stamped regions 615, a gap 630 is formed between the bottom and top metal sheets 600, 610 to define the fluid channels 210. The top metal sheet 610 can be pressed, crimped, brazed, welded (e.g., laser welded), and/or or glued (e.g., using weld-grade glue) (in general, press/crimped) in pressed/crimped regions 625 where fluid flow is not desired (e.g., to partially or fully fluidly seal the fluid channels 210), such as between neighboring fluid channels 210. The pressed/crimped regions 625 define a width of the fluid channels 210. In addition, the pressed/crimped regions 625 can provide or increase the mechanical integrity of the cooling plate 200.

The bottom metal sheet 600 can be disposed adjacent to and/or in direct physical contact with the battery module(s) 110, such as with the battery-module housing 250. The top metal sheet 610 is disposed further away from the battery module(s) 110 than the bottom metal sheet 600. In other embodiments, the top metal sheet 610 can be disposed adjacent to and/or in direct physical contact with the battery module(s) 110 and the bottom metal sheet 600 can be disposed further away from the battery module(s) 110 than the top metal sheet 610.

FIG. 6C is an isometric view of the cooling plate 200 according to an embodiment. FIG. 6D is an isometric view of the cooling plate 200 disposed on a battery tray 105 and battery modules 110 according to an embodiment.

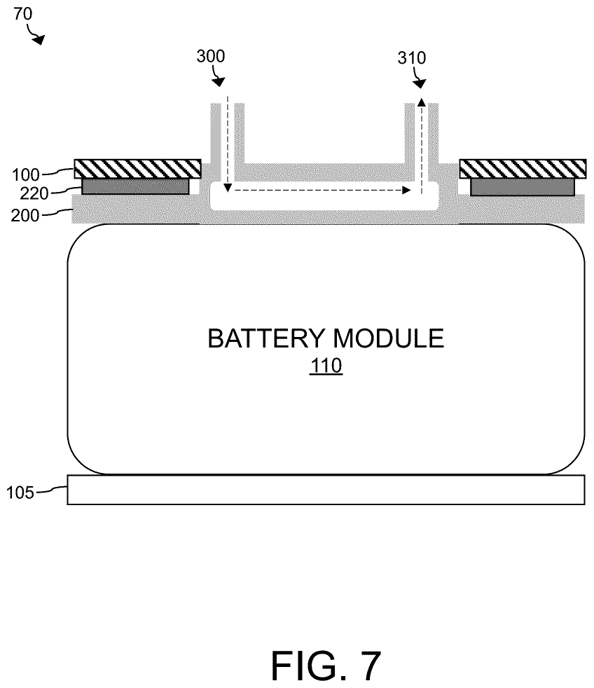

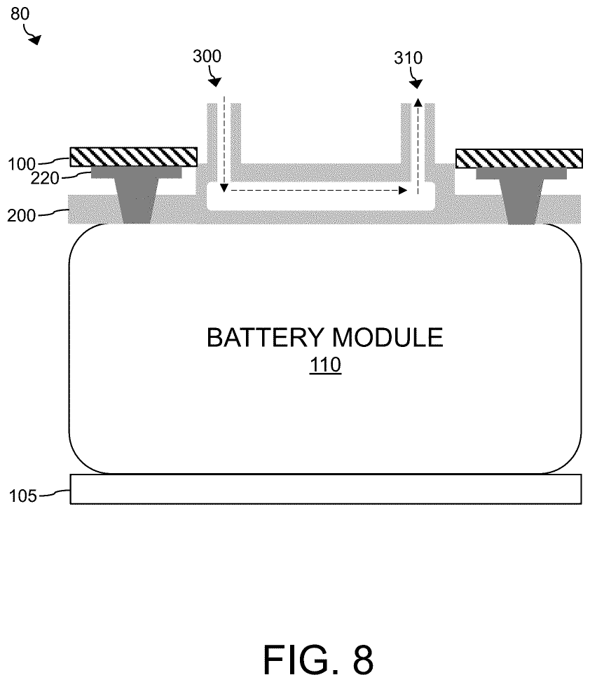

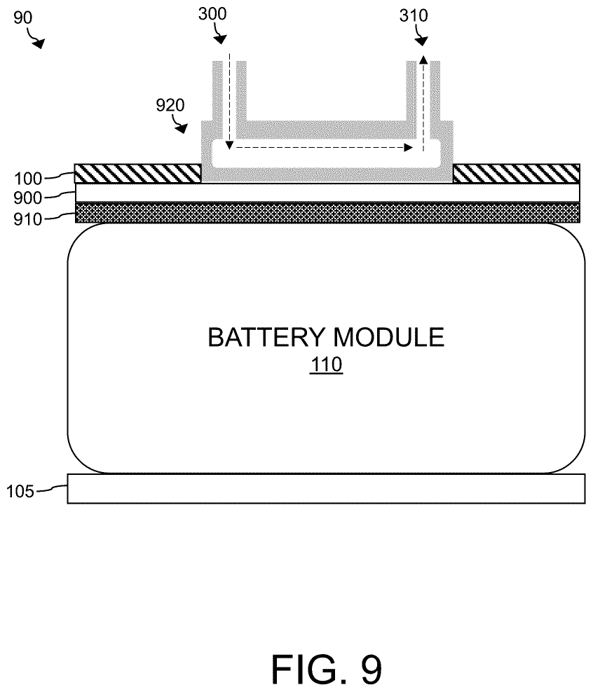

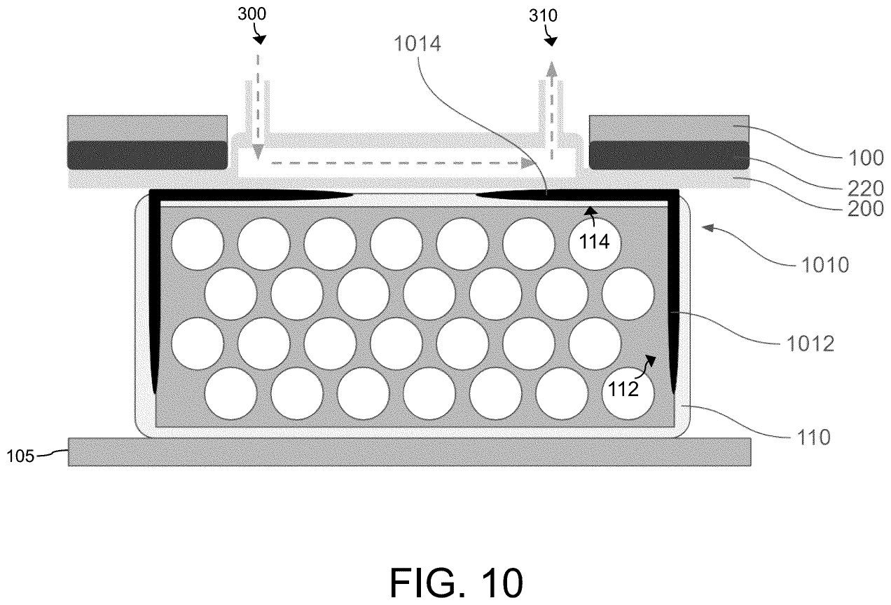

FIG. 7, FIG. 8, FIG. 9, and FIG. 10 are cross sections showing different embodiments of thermally regulated assemblies 70, 80, 90, 1000, respectively, for one or more swappable energy storage devices. The cross sections can be taken through plane 120 in FIG. 1. In assemblies 70, 80, 90, and 1000, the battery module 110 can include a thermally conductive plate 230, as discussed above.

In assembly 70, the vibration dampers 220 are placed between the cooling plate 200 and the interface plate 100. This location for the vibration dampers 220 allows the cooling plate 200 to be in direct physical contact with the battery module 110 across the width (and length) of the top of the battery module 110, which can promote thermal conductive heat transfer between the top of the battery module 110 and the bottom of the cooling plate 200. The cooling plate 200 can be thermally isolated from the interface plate 100. In addition, the cooling plate 200 can float under the vibration dampers 220.

In assembly 80, the vibration dampers 220 are in direct physical contact with the battery module 110, which can improve shock and vibration dampening of the battery module 110 compared to assembly 70. The locations at which the vibration dampers 220 physically contact the top of the battery module 110 may have increased thermal resistance due to the vibration-damper material(s) (e.g., rubber). In addition, the locations at which the vibration dampers 220 physically contact the top of the battery module 110 are not in direct physical contact with the cooling plate 200.

In assembly 90, the cooling plate 200 is located in a hole 920 defined in the interface plate 100. A metal layer 900 and a spring mesh layer 910 can be disposed between (a) the interface plate 100 and the cooling plate 200 and (b) the battery module 110. The metal layer 900 is in direct physical contact with the interface plate 100, the cooling plate 200, and the spring mesh layer 910. The spring mesh layer 910 is in direct physical contact with the metal layer 900, the cooling plate 200, and the battery module 110.

The spring mesh layer 910 can provide vibration and shock dampening for the battery module 110. The spring mesh layer 910 can be formed of steel or another material.

The metal layer 900 can function as a heat conductor to transfer thermal energy between the cooling plate 200 and the battery module 110 (via the spring mesh layer 910). The metal layer 900 can be formed of aluminum or another metal.

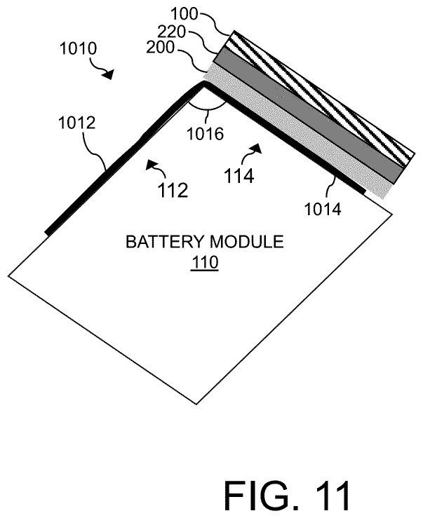

Assembly 1000 is the same as assembly 70 except that assembly 1000 includes conductive heat pipes 1010. The conductive heat pipes 1010 are in direct physical contact with one or more surfaces of the battery module 110. For example, the conductive heat pipes 1010 include a first segment 1012 configured to directly physically contact a first surface 112 of the battery module 110 and a second segment 1014 configured to directly physically contact a second surface 114 of the battery module 110. The first and second segments 1012, 1014 can be oriented at angle 1016 of about 90 degrees or another angle relative to each other, as illustrated in FIG. 11. The first segment 1012 is in direct physical contact with the first surface 112 of the battery module 110. The second segment 1014 is in direct physical contact with the cooling plate 200 and the second surface 114 of the battery module 110.

The heat pipes 1010 comprise a thermally conductive material, such as a thermally conductive metal (e.g., aluminum, copper, brass, steel, and/or another metal).

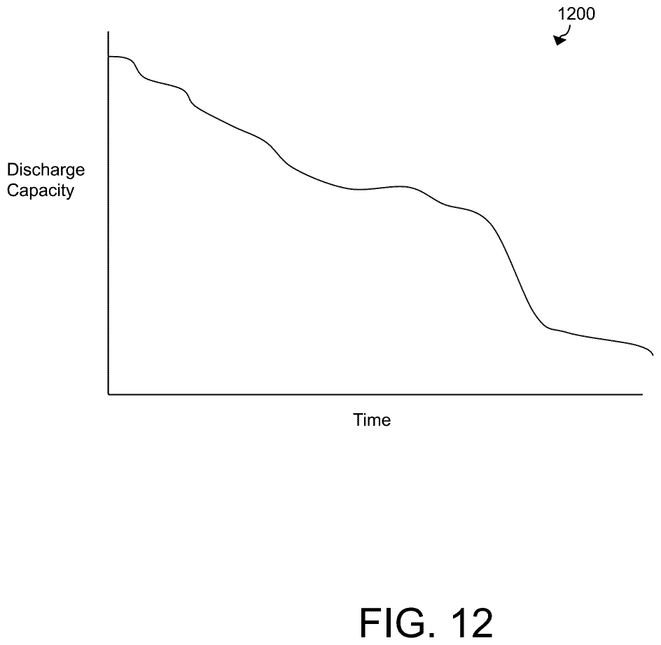

FIG. 12 is a graph 1200 that illustrates the effect of high temperature calendar aging on battery cells. High-temperature calendar aging can shorten battery-cell life significantly including discharge capacity. Maintaining battery modules and battery cells at reduced temperatures, for example using the assemblies described herein, can extend the life of battery modules and battery cells.

The cooling plate 200 has been described herein as configured to transfer heat away from a battery module 110 and reduce the temperature of the battery module 110. In other embodiments, the cooling plate 200 can be referred to as a thermally conductive plate 200 configured to transfer heat towards or away from a battery module 110. For example, a warming fluid can pass through the fluid channel(s) 210 to provide heat energy to warm a battery module 110 to increase the temperature of the battery module 110. The battery module 110 can be warmed, for example, on a cold day when the temperature of the battery module 110 is too low to charge or discharge. Thus, in some configurations the thermally conductive plate 200 can function as a warming plate 200. In other configurations, the thermally conductive plate can function for part of the time (e.g., when the weather is warm or hot such as in the summer) as a cooling plate 200 and for part of the time (e.g., when the weather is cool or cold such as in the winter) as a warming plate 200.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A cooling plate comprising:
an inlet port;
an outlet port;
a planar first metal sheet; and
a second metal sheet disposed on the first metal sheet, the second metal sheet having stamped and crimped regions that define one or more fluid channels to circulate a cooling fluid within the cooling plate, the one or more fluid channels fluidly coupled to the inlet port and the outlet port.

2. The cooling plate of claim 1, wherein at the crimped regions the second metal sheet is in direct physical contact with the first metal sheet.

3. The cooling plate of claim 2, wherein the one or more fluid channels correspond to one or more gaps between the first and second metal sheets, each gap defined by a respective stamped region and a respective pair of neighboring crimped regions.

4. The cooling plate of claim 1, wherein at the crimped regions the second metal sheet is pressed, crimped, brazed, welded, and/or or adhered to the first metal sheet.

5. The cooling plate of claim 1, wherein the first and second metal sheets comprise aluminum.

6. A thermally regulated energy storage assembly comprising:
a battery module;
a cooling plate in thermal communication with the battery module, the cooling plate having an inlet port, an outlet port, and comprising:
a planar first metal sheet; and
a second metal disposed on the first metal sheet, the second metal sheet having stamped and crimped regions that define one or more fluid channels to circulate a cooling fluid within the cooling plate, the one or more fluid channels fluidly coupled to the inlet port and the outlet port.

7. The assembly of claim 6, wherein the battery modules includes:
a housing;
a plurality of battery cells disposed in the housing; and
a thermally conductive plate having a plurality of holes, each battery cell disposed in a respective hole.

8. The assembly of claim 7, wherein the thermally conductive plate comprises a metal.

9. The assembly of claim 6, wherein at the crimped regions the second metal sheet is in direct physical contact with the first metal sheet.

10. The assembly of claim 9, wherein the one or more fluid channels correspond to one or more gaps between the first and second metal sheets, each gap defined by a respective stamped region and a respective pair of neighboring crimped regions.

11. The assembly of claim 6, further comprising one or more vibration dampeners disposed on the cooling plate.

12. The assembly of claim 6, further comprising one or more vibration dampeners disposed on the battery module.

13. A thermally regulated assembly for swappable energy storage devices, comprising:
an interface plate configured to be mechanically and electrically coupled to an electric vehicle;
a battery tray releasably attached to the interface plate;
at least one battery module disposed on the battery tray;
a cooling plate in thermal communication with the battery module, the cooling plate having an inlet port, an outlet port, and comprising:
a planar first metal sheet; and
a second metal disposed on the first metal sheet, the second metal sheet having stamped and crimped regions that define one or more fluid channels to circulate a cooling fluid within the cooling plate, the one or more fluid channels fluidly coupled to the inlet port and the outlet port.

14. The assembly of claim 13, wherein each battery module comprises:
a housing;
a plurality of battery cells disposed in the housing; and
a thermally conductive plate having a plurality of holes, each battery cell disposed in a respective hole.

15. The assembly of claim 13, further comprising:
a spring mesh layer in direct physical contact with the at least one battery module; and
a thermally conductive metal layer in direct physical contact with the spring mesh layer and the interface plate,
wherein the cooling plate is disposed in a hole in the interface plate and in direct physical contact with the thermally conductive metal layer.

16. The assembly of claim 13, further comprising a plurality of vibration dampeners attached to the interface plate and the cooling plate.

17. The assembly of claim 13, further comprising a plurality of vibration dampeners attached to the interface plate and the at least one battery module.

18. The assembly of claim 13, wherein:
at the crimped regions the second metal sheet is in direct physical contact with the first metal sheet, and
the one or more fluid channels correspond to one or more gaps between the first and second metal sheets, each gap defined by a respective stamped region and a respective pair of neighboring crimped regions.

19. The assembly of claim 13, further comprising a plurality of heat pipes disposed on and in direct physical contact with at least one battery module.

20. The assembly of claim 19, wherein each heat pipe includes first and second segments, each first segment in direct physical contact with a first side of a respective battery module, each second segment in direct physical contact with a second side of the respective battery module, each second segment disposed between the cooling plate and the second side of the respective battery module.
